(19) United States
(12) Patent Application Publication
(10) Pub. No.: US 2007/0163651 A1
(43) Pub. Date: Jul. 19, 2007

(54) Fuel tank component with weldable connector

(75) Inventors: Analis R. Quintman, Ann Arbor, MI (US); Lori L. Stephens, Shelby Township, MI (US); Gordon W. King, Pinckney, MI (US)

Correspondence Address: Anna M. Shih, 26201 Northwestern Hwy., P.O. Box 766, Southfield, MI, 48037, US

(73) Assignee: Eaton Corporation, Cleveland, OH (US)

(21) Appl. No.: 11/335,202

(22) Filed: Jan. 19, 2006

(51) Int. Cl. F16K 24/04

(52) U.S. Cl. 137/202

(57) ABSTRACT

A fuel tank component has a weldable connector that is connected to a housing via a micro-porous bonding film. The film creates a barrier to hydrocarbon permeation between two dissimilar plastics used to form the component.

### TECHNICAL FIELD

The present invention relates to fuel tank components that are attachable to polymeric fuel tanks, and more specifically to a fuel tank component having two portions made of dissimilar materials that are bonded to one another, one of which is weldable to the fuel tank, the other of which is a barrier to hydrocarbon permeation.

### BACKGROUND OF THE INVENTION

Fuel tanks are increasingly being manufactured out of weldable polymer materials, such as polyethylene. Polymeric fuel tanks and all components that are attached to the fuel tank must meet current environmental regulations. These regulations require components to be attachable to the fuel tank (e.g., via hot plate welding) and also to be a hydrocarbon barrier. Thus, some portion of the component must be chemically compatible with the fuel tank material (e.g., polyethylene) for attachment. However, attachable materials often are not good hydrocarbon barriers, and so another material may be used in the component to act as the hydrocarbon barrier.

Any components to be attached to the fuel tank cannot have hydrocarbon permeation beyond the maximum levels allowed by environmental regulations. This requires the parts in the component to minimize or prevent wicking of liquid fuel and fuel vapor. However, because different parts within the component are often made of dissimilar, and potentially incompatible, materials, some type of chemical and/or mechanical method must be incorporated to resist permeation.

There is a desire for a simple, cost-effective way to connect dissimilar materials in a component attachable to a fuel tank.

### SUMMARY OF THE INVENTION

The present invention is directed to a fuel tank component having a weldable connector that is connected to a component housing. The weldable connector is made of a material that is weldable to a polymer fuel tank, while the component housing is made of a non-weldable barrier material. A bonding film is disposed between the weldable material and the non-weldable material to bond the connector and the component housing together, creating a secure bond even if the two materials are not chemically compatible. The film also acts as a barrier against fluid and vapor wicking between the materials.

The film bonding the components of the fuel tank component simplifies the process for manufacturing the component by creating a liquid-resistant and vapor-resistant interface between two dissimilar materials. Also, because the weldable and non-weldable materials in the component do not need to be chemically compatible, the film allows the materials to be selected based on other criteria, simplifying the material selection process and making lower cost materials an option in the component.

### BRIEF DESCRIPTION OF THE DRAWINGS

FIG. 1 is a representative section view of a fuel tank component having a housing and connector structural relationship according to one embodiment of the invention;

FIG. 2 is a representative section view of the component according to another embodiment of the invention;

FIG. 3 is a representative section view of the component according to another embodiment of the invention;

FIG. 4 is a flow diagram illustrating a manufacturing process according to one embodiment of the invention.

### DETAILED DESCRIPTION OF THE EMBODIMENTS

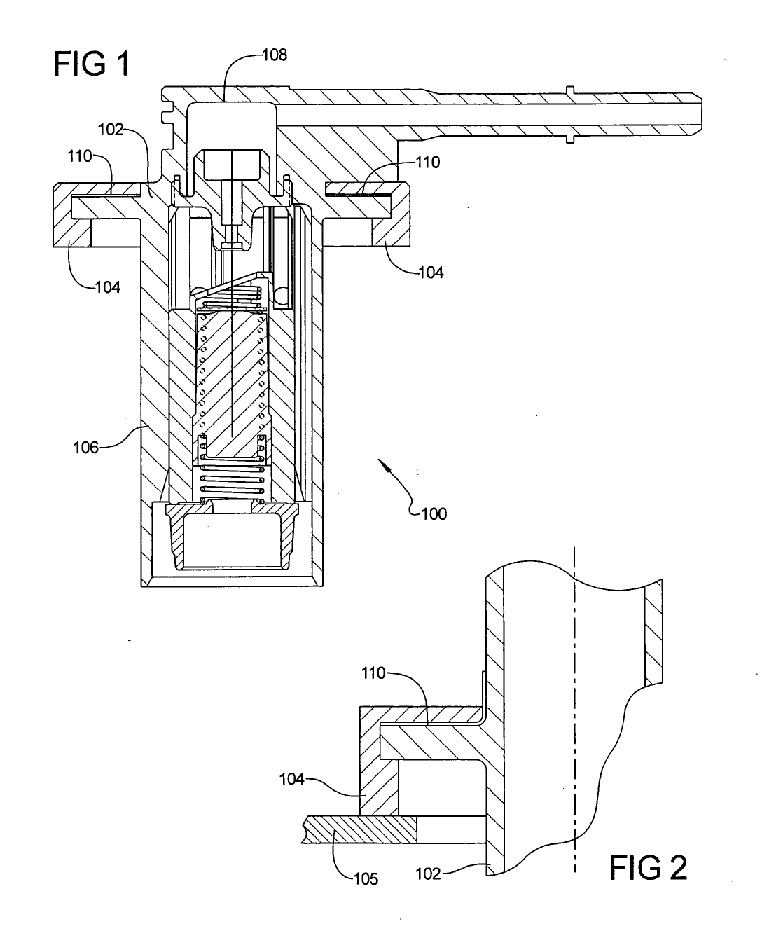

Referring to FIG. 1, the invention is generally directed to a fuel tank component 100, such as a vent valve, inlet valve, check valve, or other component having a component housing 102 with a weldable connector 104 designed to connect the component 100 to an outer surface of a polymeric fuel tank 105 (shown in FIG. 2) The housing 102 has a cylindrical lower portion 106 designed to extend into the fuel tank, and an upper portion 108 designed to extend outside the fuel tank. The component 100 itself may take any form; for example, it can be designed to vent fuel vapor from the interior of the fuel tank to the atmosphere or external vapor-treating structure. In one example, the component 100 is typically hollow, with suitable apertures and vapor pathways connecting the lower and upper portions of the main component housing 102, terminating in a vent outlet in the upper portion of the housing 102. The component 100 can, for example, be a rollover valve, a head valve, a fill control valve, or any other known component structure for venting fuel vapor from the tank or controlling fuel flow to and/or from the tank. The housing 102 can be formed of any suitable polymer material that is sufficiently heat-resistant to withstand the temperatures involved in welding techniques, such as hot-plate welding, and that has a chemical composition suitable for chemical bonding.

The weldable connector 104 is connected to the housing 102 so that at least a portion of the connector 104 can be welded to the fuel tank 105 when the component 100 is operatively positioned within the fuel tank aperture. The weldable connector 104 can surround the vent outlet structure of the upper portion of the housing 102 or can itself provide an extension of the vent outlet, such as a nozzle conduit extending from the vent outlet for connection to a vapor canister (not shown). The connector 104 is formed from a material that can be welded to the fuel tank wall 105.

To install the component 100 onto the fuel tank, the connector 104 is seated around an aperture on the fuel tank and then welded to the fuel tank wall 105 using a suitable known technique, such as hot plate welding. Once the connector 104 has been welded to the fuel tank, the housing 102 and its associated component structure are operatively fastened to fuel tank in a secure, fluid- and vapor-tight manner. Specifically, the weldable connector 104 is effectively integrated into the fuel tank wall 105 by the welding process. The welded seam between the connector 104 and the fuel tank prevents any fuel vapor or fluid fuel leakage because the connector 104 effectively becomes part of the fuel tank wall after it is welded to the fuel tank.

A bondable film 110 disposed between the housing 102 and the connector 104 securely holds the housing 102 and the connector 104 together. Both the housing 102 and the connector 104 are bonded to the film 110. The film 110 can have any configuration (e.g., a complete ring, a partial ring, concentric rings, concentric rings that cover multiple surfaces of the housing 102 and/or connector 104, dots, rectangles, strips, etc.) without departing from the scope of the invention.

The film 110 creates a structural bond between the dissimilar non-weldable and weldable materials used in the housing 102 and the connector 104, respectively, even if the materials cannot bond to each other directly. The film 110 also blocks liquid or vapor from permeating between the housing 102 and the connector 104. Using the film 110 as an interface between the housing 102 and the connector 104 increases the range of materials that can be considered for the housing 102 and the connector 104 because the materials no longer to be chemically compatible. Moreover, the strong bond created by the film 110 prevents the housing 102 and the connector 104 from separating, delaminating, or otherwise weakening, ensuring that the component 100 stays vapor- and fluid-tight over time.

In one embodiment, the material used for the film 110 creates a micro-mechanical bond between the connector 104 and the housing 102. Any material may be used for the film 110 as long as it bonds to both the weldable material and the non-weldable material in the component 100. The film 110 material may be, for example, a micro-porous polymer film manufactured by DuPont® incorporating a micro-porous tie layer that physically bonds materials together even if have no chemical compatibility (i.e., they cannot bond with each other). With this type of film, the materials used in both the component 104 and the housing 102 seep into the pores of the film 110, creating a micro-mechanical bond between the housing 102 and the film 110 and between the component 104 and the film 110. This micro-mechanical bond results in a strong bond interface between the component 104 and the housing 102 that resists hydrocarbon permeation. Thus, the materials in the component 100 itself do not need to be modified or surface-treated to form a secure bond; instead, the film 110 provides the bonding interface between the two materials. For example, the housing 102 may be made of conventional nylon or acetal and the connector 104 may be made of conventional HDPE, which normally do not bond together but which nevertheless form a securely bonded interface via the film 110.

FIG. 2 is a side section view of another possible configuration that takes advantage of the increased bond strength provided by the film 110. In this embodiment, the film 110 is applied to a larger surface area between the housing 102 and the connector 104. This greatly increases the bond strength at the interface between the housing 102 and the connector 104 at minimal cost.

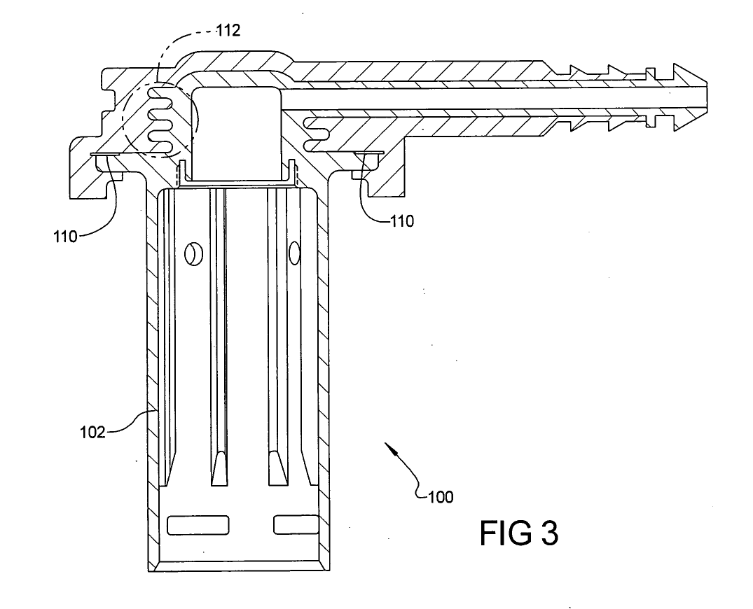

Note that the film 110 may be used to provide additional permeation resistance and/or bonding characteristics to a component 100 with a physically interlocked housing 102 and connector 104 (e.g., a housing 102 that is overmolded. FIG. 3 is a side section view of yet another possible configuration. In this embodiment, a labyrinth configuration 112 is included at the interface between the housing 102 and the connector 104. The film 110 is disposed at a flat portion 114 away from the labyrinth 112. This combination further improves the anti-wicking characteristics of the connector 100. Further, because the film 110 is cost-effective, it can be used liberally in the connector 100 to provide extra bonding strength and permeation resistance in a simple, cost-effective manner.

Thus, the inventive structure incorporating the film 110 can be used as the primary bonding mechanism for simple housing 102 and connector 104 configurations, thereby simplifying the component's 100 structure, or it can be used to provide additional bonding strength and permeation resistance to an interlocking housing 102 and connector 104. The film 110 therefore can provide enhanced properties to existing component 100 configurations as well as allow secure bonding of simplified component 100 configurations. The film 110 also acts as an anti-wicking barrier, regardless of the component configuration.

As can be seen in the figures, the housing 102 and the connector 104 are joined together via the film 110 rather than directly to each to other. The invention therefore provides more freedom in selecting the weldable and non-weldable materials because the film 110 acts as a barrier that prevents wicking between the housing 102 and the connector 104. In other words, the anti-wicking characteristics of the component 100 are provided by the film 110 and not solely by the direct bond between the housing 102 and the connector 104; in fact, the bonding characteristics of the film 110 makes the chemical compatibility of the housing 102 and the connector 104 virtually irrelevant. This allows designers to choose materials for the housing 102 and the connector 104 without having to consider whether they can bond together; in fact, the materials can be standard polymers without any treatments. Moreover, using the film 110 allows the interface between the housing 102 and the connector 104 to be simplified because the film 110, and not the interface, prevents wicking.

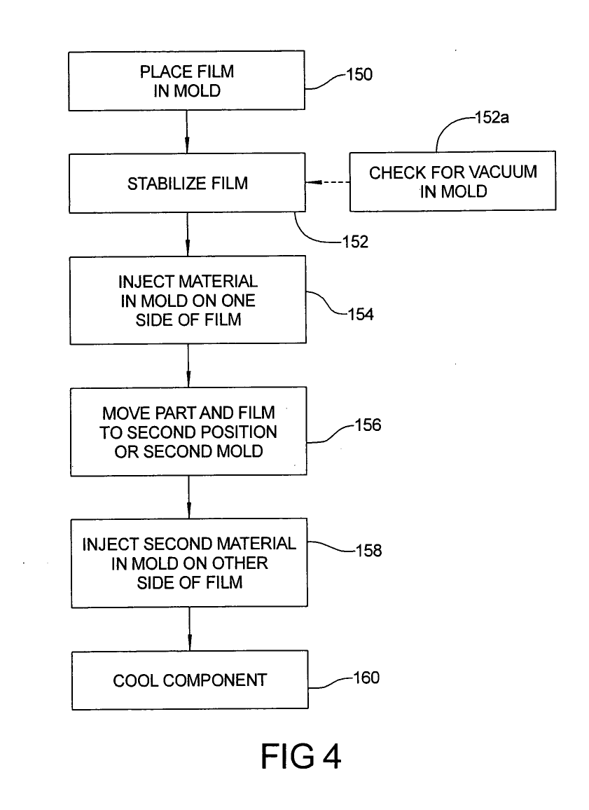

FIG. 4 is a flow diagram illustrating a manufacturing method 150 according to one embodiment of the invention. The film 110 may be incorporated between the housing 102 and the connector 104 via any compatible manufacturing method, such as overmolding, welding, two-shot molding, extrusion lamination, etc. The method shown in FIG. 4 illustrates one possible two-shot molding sequence that includes placing the film 110 in a mold (block 150). The film 110 is then stabilized so that it will not shift position before the injection molding process (block 152). In one embodiment, one or more index pins hold the film 110 in position. These index pins are retracted when the mold is closed around the film. The film 110 may be stamped so that it can fit easily over the pins, and the mold may be counter-bored so that the first injected plastic will not surround the film 110 (i.e., it leaves it exposed so that the second injected plastic will also be able to contact and bond with the film 110).

The film 110 may also be stabilized by an optional vacuum that is connected to the mold. In this case, the vacuum can also detect whether the film is properly positioned within the mold by comparing the vacuum force within the mold with the force needed to maintain the position of the film 110 (block 152a). If there is no vacuum force within the mold, this indicates a molding failure, and the molding process would stop for correction.

Once the film 110 is properly positioned and stabilized, a non-weldable material into the mold, which is disposed in a first position, on one side of the film 110 to form the connector 104 (block 154), moving the tool to a second position (block 156), then injecting a weldable material in the same tool on the other side of the film 110 to form the housing (block 158). Note that although the embodiment in FIG. 4 molds the connector 104 first and the housing 102 second, the housing 102 may be molded first instead without departing from the scope of the invention.

Once the connector 104 and the housing 102 have been formed in the molding tool, the resulting component 100 is cooled and hardened in any known manner (block 160). In one embodiment, the second material is injected into the mold before the first material hardens completely to encourage adhesion between the film 110 and the housing 102 and connector 104. The two-shot molding process allows the two dissimilar materials used to form the housing 102 and the connector 104, respectively, to shrink simultaneously during manufacturing, reducing internal molding stresses within the component 100 and binding the housing 102 and connector 104 to the film 110.

As previously noted, the component 100 may also be manufactured via other methods, such as overmolding in two separate molds, without departing from the scope of the invention.

By incorporating a film that bonds the connector and the housing in a component, the inventive structure and method prevents fluid and vapor wicking without having to rely solely on the bond between the housing and the connector. The film securely bonds the connector and housing together even if the connector and housing themselves cannot form a bond with each other. As a result, the materials for the housing and the connector can be selected to focus on the functions of each material within the component (e.g., permeation, chemical compatibility with the fuel tank material, etc.) rather than their chemical compatibility.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A fuel tank component for attachment to a polymeric fuel tank, comprising:
a housing made of a first polymer;
a connector made of a second polymer; and
a film disposed between a portion of the housing and the connector, wherein the film forms a bond between the housing and the connector, wherein the bond is resistant to hydrocarbon permeation.

2. The fuel tank component of claim 1, wherein the first polymer and the second polymer are chemically incompatible with each other.

3. The fuel tank component of claim 1, wherein the first polymer is a barrier to hydrocarbon permeation and the second polymer is weldable to the polymeric fuel tank.

4. The fuel tank component of claim 1, wherein at least one of the first polymer and the second polymer are electrically conductive.

5. The fuel tank component of claim 1, wherein the film is a polymer that mechanically bonds the first polymer and the second polymer.

6. The fuel tank component of claim 5, wherein the polymer is a micro-porous film having a plurality of pores such that the first polymer and the second polymer seep into the pores to form the mechanical bond.

7. The fuel tank component of claim 1, wherein an interface between the connector and the housing has a first surface and a second side substantially perpendicular to the first side, and wherein the film is disposed on at least one of the first side and the second side.

8. The fuel tank component of claim 7, wherein the film is disposed on both the first side and the second side.

9. The fuel tank component of claim 7, wherein the second side includes a labyrinth configuration, and wherein the film is disposed only on the first side.

10. The fuel tank component of claim 1, wherein the film is ring-shaped.

11. A fuel tank component for attachment to a polymeric fuel tank, comprising:
a housing made of a first polymer that is a barrier to hydrocarbon permeation and the second polymer;
a connector made of a second polymer that is weldable to the polymeric fuel tank; and
a film disposed between a portion of the housing and the connector, wherein the film comprises a micro-porous polymer that creates a mechanical bond between the housing and the connector.

12. The fuel tank component of claim 11, wherein the first polymer and the second polymer are chemically incompatible with each other.

13. The fuel tank component of claim 11, wherein at least one of the first polymer and the second polymer are electrically conductive.

14. A method of manufacturing a fuel tank component, comprising:
placing a micro-porous film in a mold;
injecting a first polymer into the mold on a first side of the film to form one of a connector and a housing, respectively, in a first injecting step; and
injecting a second polymer on a second side of the film to form the other of the connector and the housing in a second injecting step, wherein the film is disposed between the first polymer and the second polymer to bond the connector and the housing together.

15. The method of claim 14, wherein the first injecting step is conducted in a mold in a first position, and wherein the method further comprises moving the mold to a second position before the second injecting step.

16. The method of claim 14, wherein the first injecting step is conducted in a first mold to form said one of the connector and the housing, and wherein the method further comprises placing the film and said one of the connector and the housing in a second mold before the second injecting step.

17. The method of claim 14, further comprising stabilizing the film in the mold before the first injecting step.

18. The method of claim 17, wherein the stabilizing step comprises placing at least one index pin in contact with the film.

19. The method of claim 17, wherein the stabilizing step comprises applying a vacuum inside the mold.
